(19) United States
(12) Patent Application Publication
(10) Pub. No.: US 2025/0388082 A1
(43) Pub. Date: Dec. 25, 2025

(54) DISPLAY DEVICE FOR A VEHICLE AND ASSOCIATED MANUFACTURING METHOD

(71) Applicant: Faurecia Clarion Electronics Europe, Paris (FR)

(72) Inventor: Isabelle Guylaine Marie Geneviève MELSCOET, CHANTILLY (FR)

(21) Appl. No.: 19/248,388

(22) Filed: Jun. 24, 2025

(30) Foreign Application Priority Data
Jun. 24, 2024 (FR) FR 24 06762

(51) Int. Cl. B60K 35/22; B60K 35/40; B60K 35/50

(52) U.S. Cl. CPC B60K 35/22; B60K 35/425; B60K 35/50; B60K 2360/688; B60K 2360/92

(57) ABSTRACT

A display device for a vehicle having a screen defining a display area, an intermediate layer that includes an inner face facing the screen and an outer face, and a decorative layer that includes a first face and a second face, the first face being arranged on at least part of one of the inner face and the outer face of the intermediate layer. The display device has a plurality of apertures extending at least between the second face of the decorative layer and the first face of the decorative layer, the plurality of apertures extending at least opposite the display area.

### TECHNICAL FIELD

The present invention relates to a display device for a vehicle and a method for manufacturing such a display device.

### BACKGROUND

In vehicles, particularly motor vehicles, it is becoming increasingly common for trim elements to feature display devices comprising a screen and a display area visible to the user only when a symbol is displayed.

When the screen is off or no symbol is displayed, each display area is not directly visible to the user, and is in particular covered by a decorative pattern. In particular, the user cannot distinguish the display area from the rest of the outer surface of the trim element. On the contrary, when information is displayed, the display area, and in particular the symbol displayed, is visible to the user instead of the decorative pattern.

However, such displays are complex and costly to implement.

In particular, such display devices comprise, for example, a stack of a plurality of layers arranged between the screen and the outer surface, including in particular a decorative layer.

However, this stack of layers has unsatisfactory optical properties, particularly with regard to the transmission and scattering of light emitted by the screen.

Furthermore, this stacking of layers leads to a change in color between what is displayed on the screen and what is perceived by the user, which is detrimental to the passenger's comfort and safety.

### SUMMARY

One of the aims of the invention is therefore to remedy these drawbacks and offer a display device for a vehicle that is simple to implement and configured to satisfactorily display either the information of a screen or a decorative pattern, while at the same time exhibiting satisfactory optical properties.

To this end, the invention relates to a display device for a vehicle, comprising:
a. a screen defining a display area,
b. an intermediate layer comprising an inner face facing the screen and an outer face spaced apart from the inner face in a main direction, and
c. a decorative layer comprising a first face and a second face spaced apart from the first face in the main direction, the first face being arranged on at least part of one of the inner face and the outer face of the intermediate layer.

The display device comprises a plurality of apertures extending at least between the second face of the decorative layer and the first face of the decorative layer, said plurality of apertures extending at least opposite the display area.

Such a display device thus makes the screen visible only when a symbol is displayed on it.

In fact, when the screen is switched on, the light generated by the screen passes through the apertures, making the symbol displayed in the display area visible to the passenger. On the contrary, when the screen is off, the passenger sees only the decorative layer.

Moreover, owing to the apertures that allow light to pass directly through the screen, the colors displayed on the screen are not altered.

According to other advantageous aspects of the invention, the display device comprises one or more of the following features, taken alone or in any technically feasible combination:
Each aperture extends at least between the second face of the decorative layer and the other of the inner face and the outer face of the intermediate layer.
Each aperture opens into the second face of the decorative layer and into the other of the inner face and the outer face of the intermediate layer.
The display device comprises a homogenizing layer arranged between the decorative layer and the screen, the homogenizing layer comprising a first face arranged against the second face of the decorative layer and a second face spaced apart from the first face in the main direction.
Each aperture extends between the second face of the homogenizing layer and the outer face of the intermediate layer and opens into the second face of the homogenizing layer and the outer face of the intermediate layer.
Each aperture extends between the second face of the homogenizing layer and the first face of the decorative layer and opens into the second face of the homogenizing layer and the first face of the decorative layer.
Each aperture has a transverse dimension, measured in a transverse direction perpendicular to the main direction, of between 20 μm and 200 μm, and preferably between 30 μm and 150 μm.
The apertures are evenly distributed facing the display area.
The first face of the decorative layer is arranged on the inner face of the intermediate layer, at least between said inner face and the display area.
The display device further comprises at least one optical treatment layer, for example comprising an anti-reflective treatment.
The intermediate layer is a glass or plastic layer.
The intermediate layer follows the shape of the display area.

The invention also relates to a method for manufacturing a display device as defined above, the method comprising at least the following steps:
provision of a screen,
definition of the intermediate layer,
arrangement of the decorative layer on one of the inner face and the outer face of the intermediate layer, and
definition of a plurality of apertures between at least the second face of the decorative layer and the first face of the decorative layer.

According to other advantageous aspects of the invention, the manufacturing method comprises one or more of the following features, taken alone or in any technically feasible combination:
The step for definition of the apertures is carried out by drilling, in particular laser drilling.
The step for arrangement of the decorative layer is carried out by screen printing.

### BRIEF DESCRIPTION OF THE DRAWINGS

The invention will become clearer on reading the following description, given solely by way of non-limiting example, and made with reference to the drawings, wherein:

FIG. 1 is a schematic cross-sectional view of a display device according to a first or second embodiment of the invention,

FIG. 2 is a schematic front view of the display device of FIG. 1,

FIG. 3 is a schematic cross-sectional view of a display device according to a variant of the invention, and

FIG. 4 is a schematic cross-sectional view of a display device according to a third embodiment of the invention.

### DETAILED DESCRIPTION

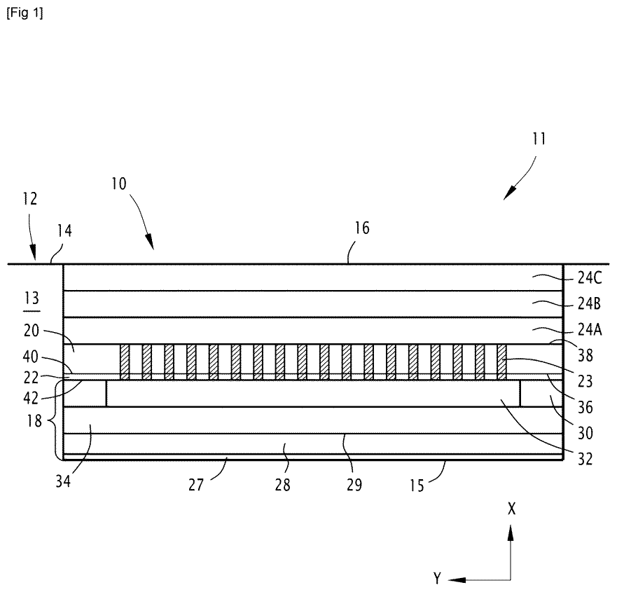

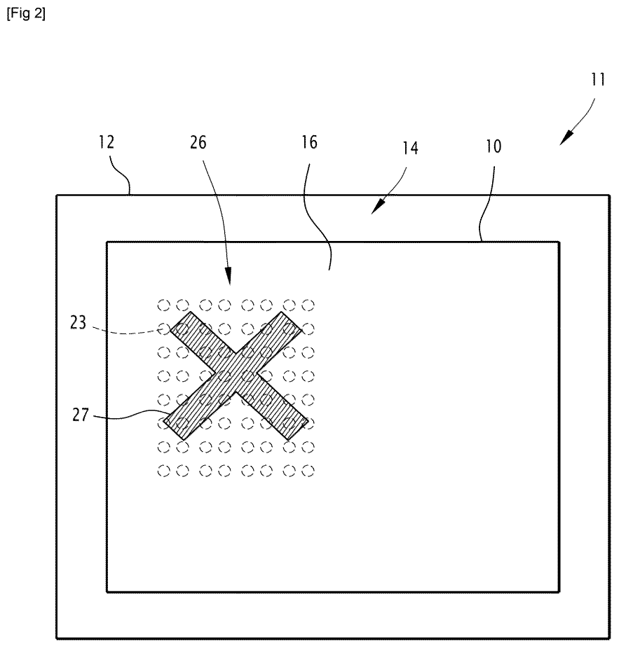

FIGS. 1 and 2 show a display device 10 for a vehicle, in particular for a motor vehicle.

More particularly, FIGS. 1 and 2 show an assembly 11 comprising the display device 10 and a vehicle trim element 12, the display device 10 advantageously being integrated into the trim element 12.

The trim element 12 is for example a dashboard arranged at the front of the passenger compartment opposite a driver seat and a passenger seat.

Alternatively, the trim element 12 is for example a central console, a door panel, a seat backrest or the like.

The trim element 12 comprises, for example, a body 13 defining an outer surface 14 advantageously facing the vehicle passenger compartment.

The outer surface 14 of the trim element 12 is preferably visible to a vehicle passenger.

The outer surface 14 of the trim element 12 extends, for example, substantially perpendicular to a main direction X.

In particular, the main direction X corresponds, for example, to the thickness direction of the trim element 12. Thickness is defined, for example, as the distance between an inner surface applied against the part of the passenger compartment on which the trim element 12 is mounted and the outer surface 14.

The outer surface 14 of the trim element 12 has a decorative appearance, for example of a solid color or defining a decorative pattern, such as an imitation wood decorative pattern.

As shown in FIG. 1, the display device 10 is preferably attached in a cavity in the body 13 of the trim element 12.

In particular, the display device 10 for example also comprises an outer surface 16, advantageously facing the passenger compartment of the vehicle.

The outer surface 16 of the display device 10 preferably extends in continuity with the outer surface 14 of the trim element 12.

More specifically, there is no interruption between the outer surface 16 of the display device 10 and the outer surface 14 of the trim element 12.

The outer surface 16 of the display device 10 is, for example, substantially perpendicular to the main direction X.

The outer surface 16 of the display device 10 is, for example, substantially flat, as shown in FIG. 1.

Alternatively (not shown), the outer surface 16 of the display device 10 has at least one curvature. For example, the outer surface 16 is substantially concave along the main direction X.

For example, the display device 10 also comprises an inner surface 15 opposite the outer surface 16 along the main direction X.

In particular, the display device 10 extends along the main direction X from the inner surface 15 to the outer surface 16.

The display device 10 comprises a screen 18, an intermediate layer 20, a decorative layer 22 and a plurality of apertures 23.

Optionally, the display device 10 further comprises at least one optical treatment layer 24A, 24B, 24C.

The screen 18 defines at least one display area 26.

In particular, when it is switched on, the screen 18 is able, for example, to display at least one symbol 25, for example related to driving the vehicle, in the display area 26.

In a particular embodiment, the screen 18 is a touch screen, that is, it can be controlled by a user's tactile contact with the display area 26.

For example, the screen 18 is substantially flat, as shown in FIG. 1.

Alternatively (not shown), particularly in the embodiment where the outer surface 16 of the display device 10 is curved, the screen 18 has at least one curvature, preferably identical to the outer surface 16 of the display device 10.

Advantageously, the screen 18 comprises a light source 27, in particular suitable for generating light at least in the display area 26.

For example, the screen 18 comprises a display panel 28, preferably a liquid crystal display (LCD) panel.

More specifically, the display panel 28 defines a display surface 29.

As can be seen in FIG. 1, the display surface 29 is preferably the face of the display panel 28 facing in the main direction X toward the outer surface 16 of the display device 10.

More specifically, the display surface 29 is substantially parallel to the outer surface 16 and is spaced apart therefrom along the main direction X toward the inner surface 15 of the display device 10.

In particular, the light source 27 is configured to illuminate the display surface 29, so as to display the symbol 25 on said display surface 29.

The screen 18 comprises, for example, an opaque cover 30 comprising a through opening 32, in particular one that allows light to pass through.

The opaque cover 30 is preferably an opaque film, that is, one that does not allow light to pass through.

The opaque cover 30 is advantageously arranged, along the main direction X, between the display surface 29 of the display panel 28 and the outer surface 16 of the display device 10.

As shown in FIG. 1, the opaque cover 30 covers the display surface 29 of the display panel 28, so that the through opening 32 preferably delimits the display area 26 of the screen 18.

Preferably, the screen 18 comprises an adhesive layer 34, in particular for securing the opaque cover 30 to the display surface 29 of the display panel 28.

The adhesive layer 34 comprises, for example, an OCA (optically clear adhesive) film or LOCA (liquid optically-clear adhesive) liquid adhesive, which preferably does not interfere with light transmission.

The intermediate layer 20 comprises an inner face 36 facing the screen 18 and an outer face 38 spaced apart from the inner face 36 along the main direction X.

In particular, along the main direction X, the inner face 36 is closer to the screen 18 and the outer face 38 is closer to the outer face 16 of the display device 10.

The intermediate layer 20 is preferably transparent, that is, it allows light to pass through it. In particular, the intermediate layer 20 has a transmittance, corresponding to the ratio of transmitted light intensity to incident light intensity, of between 25% and 95%, and preferably between 30% and 40%.

In a first embodiment, the intermediate layer 20 is, for example, a layer of plastic material.

The plastic material is preferably a transparent polymer, such as polymethyl methacrylate (PMMA) or polycarbonate (PC).

In this embodiment, the intermediate layer 20 has, for example, a thickness of between 0.5 mm and 3 mm, and more particularly between 1 mm and 2 mm, measured along the main direction X between the inner face 36 and the outer face 38.

Advantageously, the intermediate layer 20 follows the shape of the display area 26, and preferably of the screen 18.

In other words, the intermediate layer 20 advantageously has at least one curvature identical to that of the screen 18.

The decorative layer 22 comprises a first face 40 and a second face 42 spaced apart from the first face 40 along the main direction X.

As shown in FIG. 1, the decorative layer 22 is, for example, arranged on the inner face 36 of the intermediate layer 20.

More specifically, the first face 40 of the decorative layer 22 is arranged on the inner face 36 of the intermediate layer 20, at least between said inner face 36 and the display area 26.

For example, the decorative layer 22 is screen-printed on the inner face 36 of the intermediate layer 20.

Alternatively, the decorative layer 22 is produced by digital printing on the inner face 36 of the intermediate layer 20.

Alternatively, the decorative layer 22 is an adhesive film bonded to the inner face 36 of the intermediate layer 20.

Alternatively, the decorative layer 22 is a coating, in particular deposited on the inner face 36 of the intermediate layer 20.

The decorative layer 22 is, for example, a solid color or defines a decorative pattern, such as an imitation wood decorative pattern.

Preferably, the decorative layer 22 has the same decorative appearance as the outer surface 14 of the trim element 12.

In particular, the decorative layer 22 defines the decorative appearance of the outer surface 16 of the display device 10, especially when the screen 18 is switched off, for example when the display panel 28 is switched off.

In other words, when the screen 18 is switched off, a user sees the decorative pattern or color of the decorative layer 22, and preferably does not distinguish the display device 10 from the trim element 12.

As shown in FIG. 1, the plurality of apertures 23 extends between the second face 42 of the decorative layer 22 and the outer face 38 of the intermediate layer 20.

Each aperture 23 opens into the second face 42 of the decorative layer 22 and into the outer face 38 of the intermediate layer 20.

In particular, as shown in FIG. 1, each aperture 23 extends rectilinearly along the main direction X through the entire thickness of the intermediate layer 20 and the decorative layer 22.

Preferably, each aperture 23 is a micro-perforation not visible to the naked eye for a vehicle passenger observing the display device 10 from the passenger compartment of the vehicle in which the display device 10 is installed.

More particularly, each aperture 23 has a transverse dimension, measured in a transverse direction Y perpendicular to the main direction X, of between 20 μm and 200 μm, and preferably between 30 μm and 150 μm.

Each aperture 23 is, for example, a hole or a line or any other suitable shape.

Each aperture 23 has, for example, a circular cross-section.

Alternatively, each aperture 23 has a rectangular or diamond-shaped cross-section.

As shown in FIG. 2, the plurality of apertures 23 extends at least opposite the display area 26 of the screen 18.

Advantageously, each of the apertures 23 of the plurality of apertures 23 is configured to let through the light emitted by the screen 18 when it is switched on, so that a vehicle passenger can see what is displayed on the display area 26, such as for example the symbol 25 as shown in FIG. 2.

Preferably, the apertures 23 of the plurality of apertures are evenly distributed facing the display area 26.

For example, the apertures 23 are distributed at a constant pitch, for example between 20 μm and 200 μm, and preferably between 30 μm and 100 μm. The pitch corresponds to the distance between two adjacent apertures 23 in the transverse direction Y.

Preferably, the transverse dimension of each of the apertures 23 and/or the pitch are selected taking into account the decorative pattern and/or the characteristics of the screen 18, in particular the display panel 28, such as pixel size, number of pixels and dimensions of the display panel 28. The at least one optical treatment layer 24A-C is preferably arranged between the outer surface 16 of the display device 10 and the intermediate layer 20.

The at least one optical treatment layer 24A-C is advantageously transparent, and in particular has a transmittance, corresponding to the ratio of transmitted light intensity to incident light intensity, greater than 90%, and preferably greater than 95%.

Preferentially, the display device 10 comprises three optical treatment layers 24A-C superimposed along the main direction X.

Each of the optical treatment layers 24A-C is, for example, a film comprising a specific optical treatment or is formed by depositing a coating comprising a specific optical treatment.

In particular, the at least one optical treatment layer 24A-C comprises, for example, a first layer 24A comprising an anti-glare treatment.

Furthermore, the at least one optical treatment layer 24A-C comprises, for example, a second layer 24B comprising an anti-reflective treatment.

Moreover, the at least one optical treatment layer 24A-C comprises, for example, a third layer 24C comprising an anti-scratch and/or easy-to-clean treatment.

It is understood that the same optical treatment layer 24A-C may have two or more of the optical treatments described above.

A method for manufacturing such a display device 10 will now be described.

In a first step, a screen 18 is provided.

In a second step, the intermediate layer 20 is defined.

For example, the intermediate layer 20 is defined by extruding and then cutting a plastic sheet, so as to define the intermediate layer 20 to the desired dimensions.

The decorative layer 22 is then arranged on the inner face 36 of the intermediate layer 20.

In particular, the step for arrangement of the decorative layer 22 is carried out by screen-printing.

Alternatively, the step for arrangement of the decorative layer 22 is carried out by digital printing on the inner face 36 of the intermediate layer 20.

In particular, the step for arrangement of the decorative layer 22 by screen-printing or printing is carried out using suitable inks, such as a semi-transparent ink and/or an ink compatible with the material of the decorative layer 22.

Alternatively, the step for arrangement of the decorative layer 22 is carried out by depositing a coating, in particular on the inner face 36 of the intermediate layer 20.

The method then comprises a step for defining the plurality of apertures 23 between the second face 42 of the decorative layer 22 and the outer face 38 of the intermediate layer 20.

Preferably, the step for defining apertures 23 is carried out by drilling, in particular by laser drilling and/or using masking techniques.

Alternatively, the step of defining the apertures 23 is carried out by chemical etching.

The method then comprises a shaping step so that the intermediate layer 20, and preferably the assembly formed with the decorative layer 22, conforms to the shape of the screen 18.

This shaping step can be used, for example, to define one or more curves.

For example, this shaping step is carried out by cold forming, particularly when the curvature to be defined is small.

Alternatively, this shaping step is carried out by hot forming, particularly when the curvature to be defined is strong and/or complex.

In particular, this hot forming step is carried out by pressing at a temperature above 140° C.

Optionally, at least one optical treatment layer 24A-C is deposited on the outer face 38 of the intermediate layer 20, for example by depositing one or more coatings comprising a specific optical treatment.

This step of depositing the at least one optical treatment layer 24A-C is carried out, for example, after the step of defining the intermediate layer 20 or before the shaping step.

The assembly of layers thus formed is then preferably arranged on the screen 18, so as to form the display device 10 as described above.

Such a display device 10 thus makes the screen 18 visible only when a symbol 25 is displayed thereupon.

In fact, when the screen 18 is switched on, the light generated by the screen 18 passes through the apertures 23, making the symbol 25 displayed in the display area 26 visible to the passenger. On the contrary, when the screen 18 is switched off, the passenger only sees the decorative layer 22, in particular owing to the very small size of the apertures 23, which are not visible to the naked eye; owing to the apertures 23, which allow reflected ambient light to pass directly through, a decorative pattern is thus displayed on the display area 26.

Moreover, owing to the apertures 23 that allow light to pass directly through the screen 18, the colors displayed on the screen 18 are not altered.

Such a display device 10 also has the advantage of being easy and inexpensive to manufacture.

The invention is not limited to the exemplary embodiments and variants disclosed hereinbefore.

In particular, the order of the steps in the method described above may be different.

For example, alternatively, the shaping step is carried out before the step of defining the apertures 23.

According to a variant which is not shown, the decorative layer 22 is not arranged on the inner face 36 of the intermediate layer 20, but on its outer face 38.

In this variant, the apertures 23 are defined between the second face 42 of the decorative layer 22 and the inner face 36 of the intermediate layer 20.

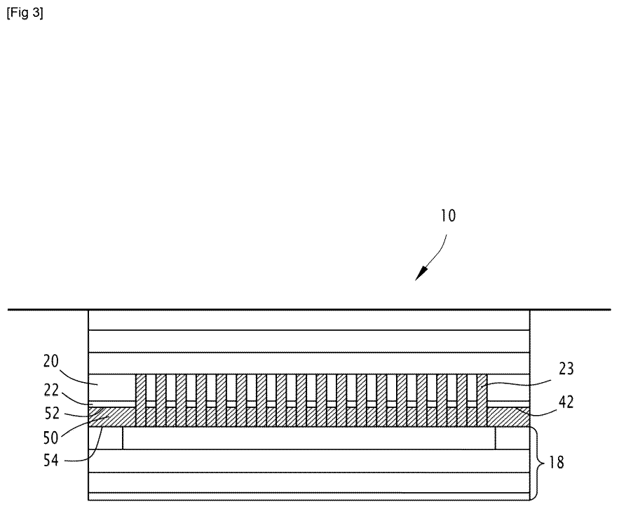

According to a variant shown in FIG. 3, the display device 10 further comprises a homogenizing layer 50, in particular arranged between the decorative layer 22 and the screen 18

More specifically, the homogenizing layer 50 comprises a first face 52 arranged against the second face 42 of the decorative layer 22, and a second face 54 spaced apart from the first face 52 along the main direction X.

The apertures 23 preferably extend into the homogenizing layer 50, so as to let through the light emitted by the screen 18 when it is switched on.

More specifically, each aperture 23 extends between the outer face 38 of the intermediate layer 20 and the second face 54 of the homogenizing layer 50, as can be seen in FIG. 3.

In particular, in this variant, each aperture 23 opens into the second face 54 of the homogenizing layer 50.

The homogenizing layer 50 is, for example, a light-scattering or light-isolating layer.

The homogenizing layer 50 comprises, for example, a nanoscale structure and a refractive index matching layer deposited on the structure to achieve enhanced light-scattering effects.

For example, the homogenizing layer 50 is printed on the second face 42 of the decorative layer 22.

Alternatively, the homogenizing layer 50 is an adhesive film bonded to the second face 42 of the decorative layer 22.

Alternatively, the homogenizing layer 50 is a coating, in particular deposited on the second face 42 of the decorative layer 22.

The homogenizing layer 50 has the advantage of reducing light leakage and thus homogenizing the light passing through the apertures 23.

According to a second embodiment, the intermediate layer 20 is not a plastic layer, but a glass layer.

In this second embodiment, the intermediate layer 20 has, for example, a thickness of between 0.2 μm and 2 mm, and more particularly between 0.55 μm and 1.3 mm, measured along the main direction X between the inner face 36 and the outer face 38.

In this second embodiment, the step of defining the intermediate layer 20 is carried out, for example, by cutting a glass plate to the desired dimensions.

Preferably, the method further comprises a step for chemically treating the intermediate layer 20, for example by chemical quenching.

Said intermediate layer 20 is shaped, for example, by cold forming.

Alternatively, the step of shaping said intermediate layer 20 is carried out, for example, by high-temperature hot forming, that is, at a temperature above 650° C.

This high-temperature hot-forming shaping step is preferably carried out before the step for arrangement of the decorative layer 22 and before the step for definition of the apertures 23.

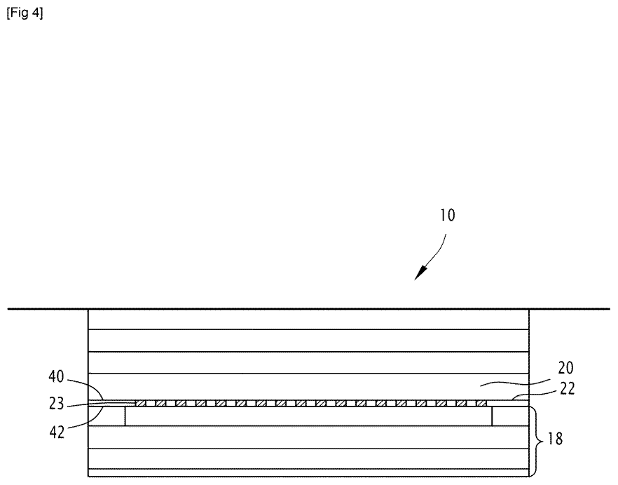

According to a third embodiment shown in FIG. 4, the apertures 23 do not extend into the intermediate layer 20.

In other words, the apertures 23 do not extend between the inner face 36 and the outer face 38 of said intermediate layer 20.

In particular in this third embodiment, the apertures 23 extend between the first face 40 and the second face 42 of the decorative layer 22.

More specifically, in the embodiment shown in FIG. 4, each aperture 23 opens into the first face 40 of the decorative layer 22 and into the second face 42 of the decorative layer 22.

In this embodiment, the step of defining the apertures 23 is carried out by defining the plurality of apertures 23 between the first face 40 of the decorative layer 22 and the second face 42 of the decorative layer 22.

This embodiment has the advantage of reducing the risk of uncontrolled light leakage and avoiding the potential risk of clogging the apertures defined in the intermediate layer 20.

As an alternative to this embodiment, the display device 10 further comprises the homogenizing layer 50, in particular arranged between the decorative layer 22 and the screen 18, as described above.

In this variant, each aperture 23 extends between the first face 40 of the decorative layer 22 and the second face 54 of the homogenizing layer 50.

1. A display device for a vehicle, comprising:
a screen defining a display area,
an intermediate layer comprising an inner face facing the screen and an outer face spaced apart from the inner face in a main direction, and
a decorative layer comprising a first face and a second face spaced apart from the first face in the main direction, the first face being arranged on at least part of one of the inner face and the outer face of the intermediate layer,
wherein the display device comprises a plurality of apertures extending at least between the second face of the decorative layer and the first face of the decorative layer, said plurality of apertures extending at least opposite the display area.

2. The display device according to claim 1, wherein each aperture extends at least between the second face of the decorative layer and the other of the inner face and the outer face of the intermediate layer.

3. The display device according to claim 2, wherein each aperture opens into the second face of the decorative layer and into the other of the inner face and the outer face of the intermediate layer.

4. The display device according to claim 1, wherein the display device comprises a homogenizing layer arranged between the decorative layer and the screen, the homogenizing layer comprising a first face arranged against the second face of the decorative layer and a second face spaced apart from the first face in the main direction.

5. The display device according to claim 4, wherein each aperture extends between the second face of the homogenizing layer and the outer face of the intermediate layer and opens into the second face of the homogenizing layer and the outer face of the intermediate layer.

6. The display device according to claim 4, wherein each aperture extends between the second face of the homogenizing layer and the first face of the decorative layer and opens into the second face of the homogenizing layer and the first face of the decorative layer.

7. The display device according to claim 1, wherein each aperture has a transverse dimension, measured in a transverse direction perpendicular to the main direction, of between 20 μm and 200 μm.

8. The display device according to claim 1, wherein the apertures are evenly distributed opposite the display area.

9. The display device according to claim 1, wherein the first face of the decorative layer is arranged on the inner face of the intermediate layer, at least between said inner face and the display area.

10. The display device according to claim 1, further comprising at least one optical treatment layer, for example comprising an anti-reflective treatment.

11. The display device according to claim 1, wherein the intermediate layer is a glass layer or a layer of plastic material.

12. The display device according to claim 1, wherein the intermediate layer conforms to the shape of the display area.

13. A method for manufacturing a display device according to claim 1, the method comprising at least the following steps:
providing a screen,
defining the intermediate layer,
arranging the decorative layer on one of the inner face and the outer face of the intermediate layer, and
defining a plurality of apertures between at least the second face of the decorative layer and the first face of the decorative layer.

14. The manufacturing method according to claim 13, wherein the step for definition of the apertures is carried out by drilling.

15. The manufacturing method according to claim 13, wherein the step for arrangement of the decorative layer is carried out by screen printing.

16. The display device according to claim 7, wherein the transverse dimension is between 30 μm and 150 μm.

17. The manufacturing method according to claim 14, wherein the drilling is laser drilling.
